(19) United States
(12) Patent Application Publication
(10) Pub. No.: US 2014/0059704 A1
(43) Pub. Date: Feb. 27, 2014

(54) CLIENT DEVICE, SERVER, AND STORAGE MEDIUM

(71) Applicant: SONY CORPORATION, Tokyo (JP)

(72) Inventors: YASUNORI KAMADA, Kanagawa (JP); KAZUNORI HAYASHI, Tokyo (JP); TAKAYASU KON, Tokyo (JP); YOICHIRO SAKO, Tokyo (JP)

(73) Assignee: SONY CORPORATION, Tokyo (JP)

(21) Appl. No.: 13/965,461

(22) Filed: Aug. 13, 2013

(30) Foreign Application Priority Data
Aug. 24, 2012 (JP) 2012-185281

(51) Int. Cl. G06F 21/60

(52) U.S. Cl. CPC G06F 21/60
USPC 726/28

(57) ABSTRACT

Provided is a client device, including an identification unit that identifies a person included in content information acquired by a content information acquisition unit, and generates first identification information indicating an identified person, a communication unit that associates and transmits the content information and the first identification information to an external device, and a generation unit that generates an access request for content information stored in the external device. The access request includes second identification information specifying a user who accesses the content information stored in the external device, and the communication unit transmits the access request to the external device, and from the external device receives content information that is at least partially access-restricted based on a comparison by the external device between the second identification information included in the access request and the first identification information associated with the content information stored in the external device.

### BACKGROUND

The present disclosure relates to a client device, a server, and a storage medium.

Typically, many people take photographs and video to save memories at amusement centers and tourist locations. Also, at large-scale amusement parks referred to as theme parks, cameras are installed at key locations in attractions. Such cameras automatically record images when the ride arrives, and these pictures are then sold as prints to desiring customers after the attraction ends.

As a technology regarding automatic recording by such fixed cameras, Japanese Unexamined Patent Application Publication No. 2001-177750, for example, discloses an image recording system that distributes communication means such as radio-frequency tags only to visitors who are to be recorded, and records images on the basis of detecting identification information transmitted from such communication means.

Also, Japanese Unexamined Patent Application Publication No. 2002-112074 discloses a system that records images using fixed cameras on the basis of detecting a subject in a recording location according to an infrared or other sensor.

Meanwhile, another recent development is a wearable camera which is worn on a person's body and which automatically and continually records one's surroundings. Wearable cameras are also referred to as life logging cameras, since such cameras continually record one's daily life and activities.

Regarding such wearable cameras, Japanese Unexamined Patent Application Publication No. 2001-274936, for example, discloses technology that wirelessly connects information clients together to construct a personal wearable network that connects to the Internet.

In addition, Japanese Unexamined Patent Application Publication No. 2004-356970 discloses technology that switches between an ordinary recording mode, and an automatic recording mode that automatically records images while a camera is worn on one's body.

### SUMMARY

Currently, with the appearance of automatically recording cameras typified by devices such as fixed cameras and wearable cameras as discussed above, as well as the increasingly large amounts of imaged material due to improvements in the storage capacities of digital cameras and the like, there is a desire for further improvement in the performance of access restriction technology with respect to images depicting oneself.

Thus, the present disclosure proposes a new and improved client device, server, and storage medium capable of imposing incremental access restrictions on content information in which oneself is recorded.

According to an embodiment of the present disclosure, there is provided a client device, including an identification unit that identifies a person included in content information acquired by a content information acquisition unit, and generates first identification information indicating an identified person, a communication unit that associates and transmits the content information and the first identification information to an external device, and a generation unit that generates an access request for content information being stored in the external device. The access request includes second identification information specifying a user who accesses the content information being stored in the external device, and the communication unit transmits the access request to the external device, and from the external device receives content information that is at least partially access-restricted based on a comparison by the external device between the second identification information included in the access request and the first identification information associated with the content information being stored in the external device.

According to an embodiment of the present disclosure, there is provided a server, including a communication unit that receives content information from a content information acquisition device, and receives an access request from an external client, an identification unit that identifies a person included in the content information, and generates first identification information indicating the person, a storage control unit that associates and stores the content information and the first identification information in a storage unit, and a communication control unit that, when the communication unit receives from the external client the access request including second identification information that specifies a user who accesses the content information being stored in the storage unit, controls the communication unit to transmit, to the external client, content information that is generated and at least partially access-restricted based on a comparison between the second identification information included in the access request and the first identification information associated with the content information being stored in the storage unit.

According to an embodiment of the present disclosure, there is provided a non-transitory computer-readable storage medium having a program stored therein, the program causing a computer to execute identifying a person included in content information, and generating first identification information indicating an identified person, associating and transmitting the content information and the first identification information to an external device, generating an access request for content information being stored in the external device, the access request including second identification information specifying a user who accesses the content information, transmitting the access request to the external device, and receiving, from the external device, content information that is at least partially access-restricted based on a comparison by the external device between the second identification information included in the access request and the first identification information associated with the content information being stored in the external device.

According to an embodiment of the present disclosure, there is provided a non-transitory computer-readable storage medium having a program stored therein, the program causing a computer to execute receiving content information from a content information acquisition device, identifying a person included in the content information, and generating first identification information indicating the person, associating and storing the content information and the first identification information, receiving, from an external client, an access request including second identification information specifying a user who accesses the stored content information, and transmitting, to the external client, content information that is generated and at least partially access-restricted based on a comparison between the second identification information included in the access request and the first identification information associated with the stored content information.

According to an embodiment of the present disclosure as described above, it is possible to impose incremental access restrictions on content information in which oneself is recorded.

### BRIEF DESCRIPTION OF THE DRAWINGS

FIG. 1 is a diagram summarizing a content information management system according to an embodiment of the present disclosure;

FIG. 2 is a diagram illustrating a configuration of a content information management system according to the first embodiment;

FIG. 3 is a diagram illustrating a configuration of an automatic imaging device according to the first embodiment;

FIG. 4 is a diagram illustrating a configuration of a server according to the first embodiment;

FIG. 5 is a flowchart illustrating an operational process of an automatic imaging device according to the first embodiment;

FIG. 6 is a diagram for explaining an example of a process that transmits data stored in an automatic imaging device according to the first embodiment;

FIG. 7 is a diagram summarizing content information access by a content information management system according to the first embodiment;

FIG. 8 is a sequence diagram illustrating a content information access operational process according to the first embodiment;

FIG. 9 is a diagram illustrating an example of an access restriction process by a server according to the first embodiment;

FIG. 10 is a diagram illustrating an example of an access restriction process by a server according to the first embodiment;

FIG. 11 is a diagram illustrating an exemplary display of a video block before and after editing by a server according to the first embodiment;

FIG. 12 is a flowchart illustrating an operational process of an automatic imaging device according to a first modification of the first embodiment;

FIG. 13 is a diagram for summarizing a content information management system according to a second modification of the first embodiment;

FIG. 14 is a diagram for summarizing a content information management system according to a second modification of the first embodiment; and

FIG. 15 is a diagram illustrating a configuration of a content information management system according to the second embodiment.

### DETAILED DESCRIPTION OF THE EMBODIMENT(S)

Hereinafter, preferred embodiments of the present disclosure will be described in detail with reference to the appended drawings. Note that, in this specification and the appended drawings, structural elements that have substantially the same function and structure are denoted with the same reference numerals, and repeated explanation of these structural elements is omitted.

Hereinafter, the description will proceed in the following order:

1. Summary of content information management system according to an embodiment of the present disclosure

2. Embodiments
2-1. First embodiment
(2-1-1. Configuration)
(2-1-2. Content information collection operations)
(2-1-3. Content information access)
(2-1-4. Effects)
2-2. First modification of first embodiment
(2-2-1. Operation)
(2-2-2. Effects)
2-3. Second modification of first embodiment
(2-3-1. Configuration and operation)
(2-3-2. Effects)
2-4. Second embodiment
(2-4-1. Configuration)

(2-4-2. Operation)
(2-4-3. Effects)

3. Conclusion

### 1. Summary of Content Information Management System According to an Embodiment of the Present Disclosure

The present disclosure may be carried out in various embodiments, examples of which are described in detail from sections <2-1. First embodiment> to <2-4. Second embodiment>. Also, a client device (automatic imaging device 2 and information processing device 7) included in a content information management system according to the respective embodiments is equipped with:

A. an identification unit (controller 24) that identifies a person included in content information acquired by a content information acquisition unit (imaging unit 20, mic 21), and generates first identification information indicating the identified person;

B. a communication unit (communication unit 25 and information processing device 7) that associates and transmits the content information and the first identification information to an external device (server 4); and

C. a generation unit (information processing device 7) that generates an access request for content information stored in the external device; wherein

D. the access request includes second identification information specifying a user who accesses the content information stored in the external device, and

E. the communication unit transmits the access request to the external device, and from the external device receives content information that is at least partially access-restricted on the basis of a comparison by the external device between the second identification information included in the access request and the first identification information associated with the content information stored in the external device.

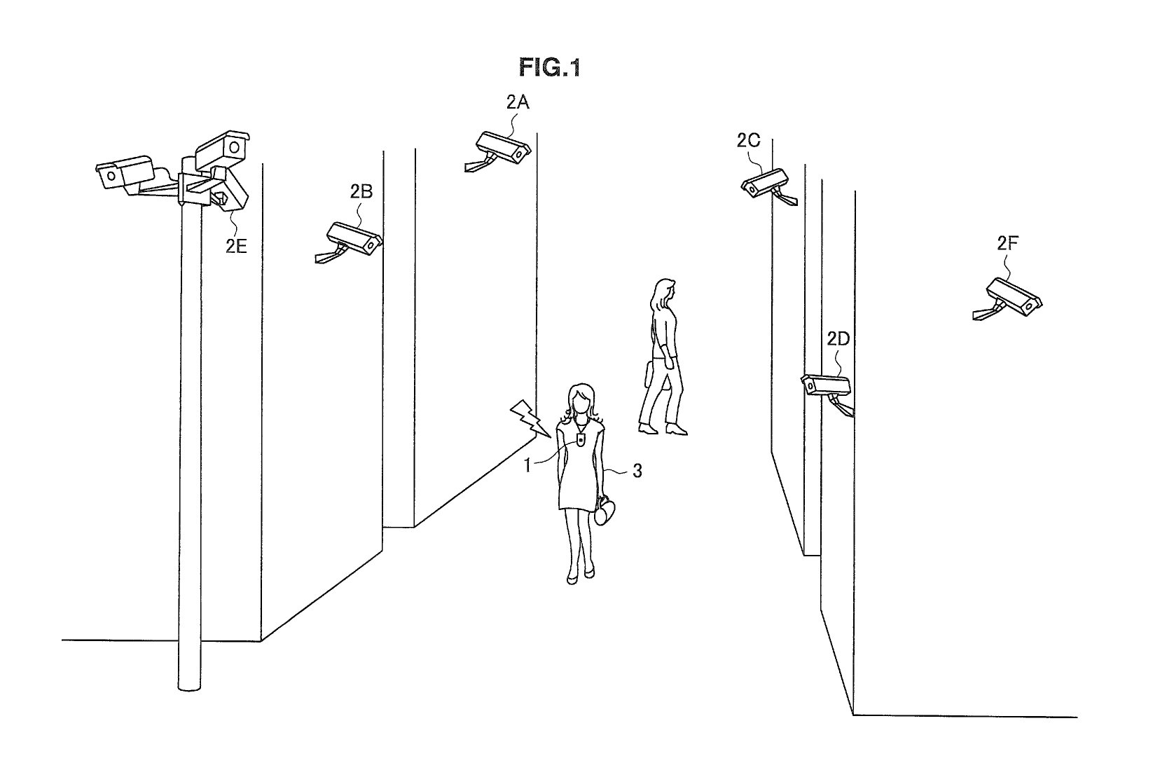

First, a basic configuration of a content information management system common to each of such embodiments will be described with reference to FIG. 1.

FIG. 1 is a diagram summarizing a content information management system according to an embodiment of the present disclosure. As illustrated in FIG. 1, automatic imaging devices 2A to 2F are installed at fixed points throughout an outdoor area. The automatic imaging devices 2A to 2F include various sensors such as a camera and microphone (hereinafter abbreviated to mic), and continually record audio and video. A content information management system according to the present disclosure envisions situations in which many automatic imaging devices 2 are disposed not only outdoors as illustrated in FIG. 1, but also indoors. Also, hereinafter, the automatic imaging devices 2A to 2F will be collectively designated the automatic imaging devices 2 when not being described individually.

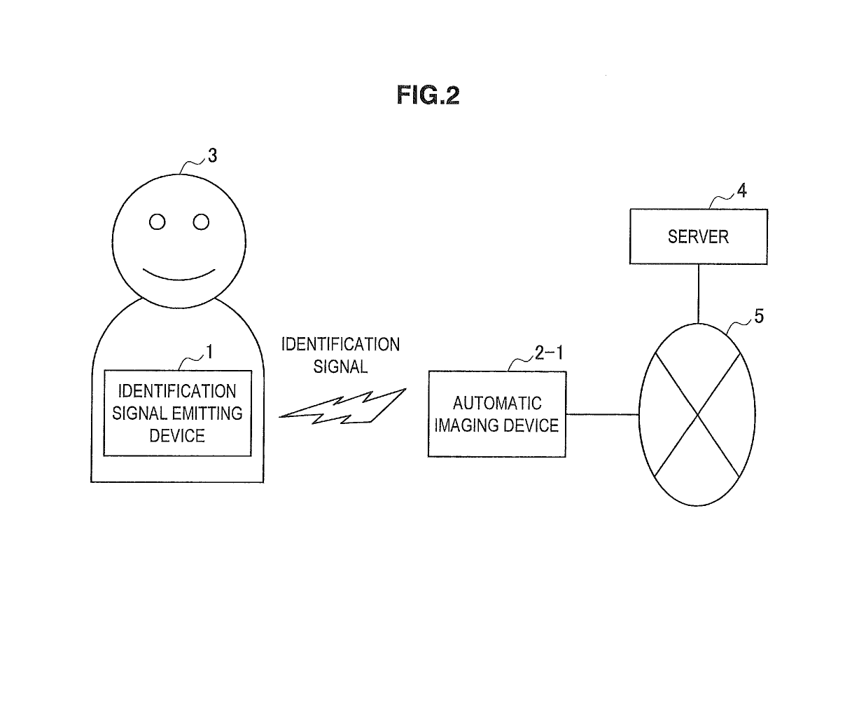

Meanwhile, the user 3 illustrated in FIG. 1 is wearing a wearable identification signal emitting device 1 able to emit an identification signal corresponding to identification information indicating oneself. The identification signal emitted by the identification signal emitting device 1 is received (accepted) by the automatic imaging devices 2 disposed near the user 3. At this point, the automatic imaging devices 2 link (associate) data recording audio/video data of the user 3 (content information) with identification information indicating the user 3 who is identified on the basis of the received identification signal, and cause the linked information to be stored in an external device (see the server 4 illustrated in FIG. 2) connected via a network. For this reason, the user 3 is able to use his or her own identification information to access content information which is stored in an external device and which is associated with his or her own identification information, or in other words, data recording audio/video of him- or herself (the data may be video, images, audio, or some combination thereof).

In this way, a user 3 gains the convenience of being able to acquire only content information associated with his or her own identification information (at least partially access-restricted content information) from among content information stored in an external device. Meanwhile, a user 3 is also able to protect his or her own privacy by incrementally restricting access by other persons to content information associated with his or her own identification information.

Note that the identification signal emitting device 1 is realized by a radio information code such as an integrated circuit (IC) tag or radio-frequency identification (RFID) tag, for example. Otherwise, the identification signal emitting device 1 may be realized by an optical information code such as a barcode or a two-dimensional code. In addition, the automatic imaging devices 2 may also take physical features of the user 3 as an identification signal corresponding to the identification information indicating oneself that is emitted from the identification signal emitting device 1. In other words, the automatic imaging devices 2 identify the user 3 on the basis of the physical features of a person depicted in an acquired image. For example, the automatic imaging devices 2 may conduct processing such as face recognition on an acquired image to identify a user 3.

Moreover, the method of wearing the identification signal emitting device 1 is not limited to a method of being worn around the user 3's neck by a lanyard attached to the identification signal emitting device 1 as illustrated in FIG. 1. For example, the identification signal emitting device 1 may also be attached to the user 3's hat, clothing, shoes, glasses, sunglasses, or the like, and may also be inserted into a pocket of the user 3's clothing.

In addition, besides being an installed device installed at a fixed point as illustrated in FIG. 1, an automatic imaging device 2 may also be a wearable device worn by another user, an animal, or the like, and may also be an attached device or built-in device that is attached to or built into a moving object such as a vehicle. Also, an automatic imaging device 2 may be a held device such as a digital camera that is held by another user.

The above thus summarizes a content information management system according to an embodiment of the present disclosure. Next, such a content information management system according to the present disclosure will be described in detail by citing several embodiments.

### 2. Embodiments

### 2-1. First Embodiment

According to the present embodiment, it is possible to provide a user 3 with easy access to content information, as well as privacy protection. Hereinafter, a configuration of the present embodiment will be described with reference to FIGS. 2 to 4.

[2-1-1. Configuration]

FIG. 2 is a diagram illustrating a configuration of a content information management system according to the first embodiment. As illustrated in FIG. 2, the content information management system includes an identification signal emitting device 1 worn by a user 3, an automatic imaging device 2-1 disposed near the user 3, and a server 4. In addition, the automatic imaging device 2-1 connects to the server 4 via a network 5.

The identification signal emitting device 1 is a wearable device able to emit an identification signal corresponding to identification information indicating the user 3.

In addition, the automatic imaging device 2-1 continually records audio/video, and transmits data recording audio/video (content information) to the server 4. Herein, as discussed earlier, the automatic imaging device 2-1 links data recording audio/video of the user 3 with identification information indicating the user 3, who is identified on the basis of the identification signal received from the identification signal emitting device 1, and transmits the linked information to the server 4.

The network 5 is realized by a network such as the Internet, a dedicated line, or an Internet Protocol-virtual private network (IP-VPN), for example.

The server 4 manages operations such as the storage and delivery of content information. For example, the server 4 stores content information associated with identification information of the user 3 transmitted by the automatic imaging device 2-1. Additionally, the server 4 transmits content information associated with identification information of the user 3 to the user 3 in accordance with an access request from the user 3.

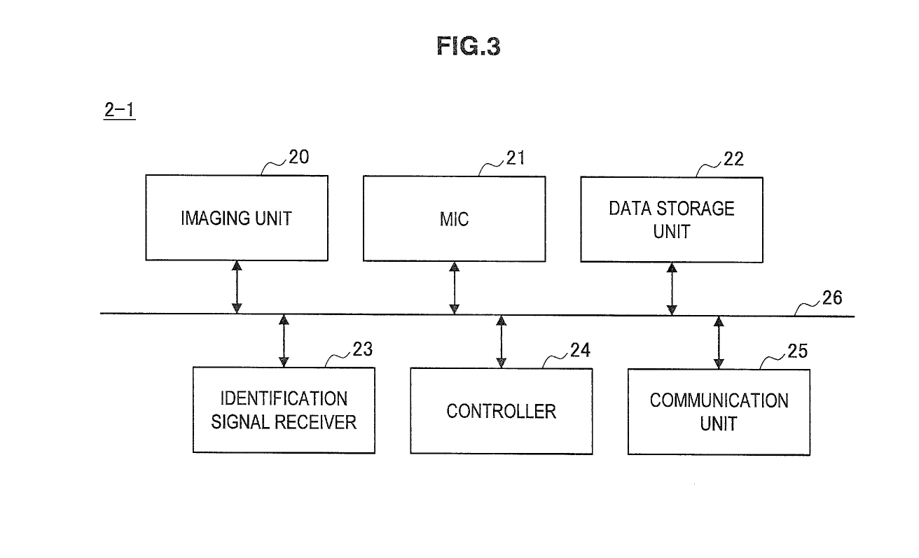

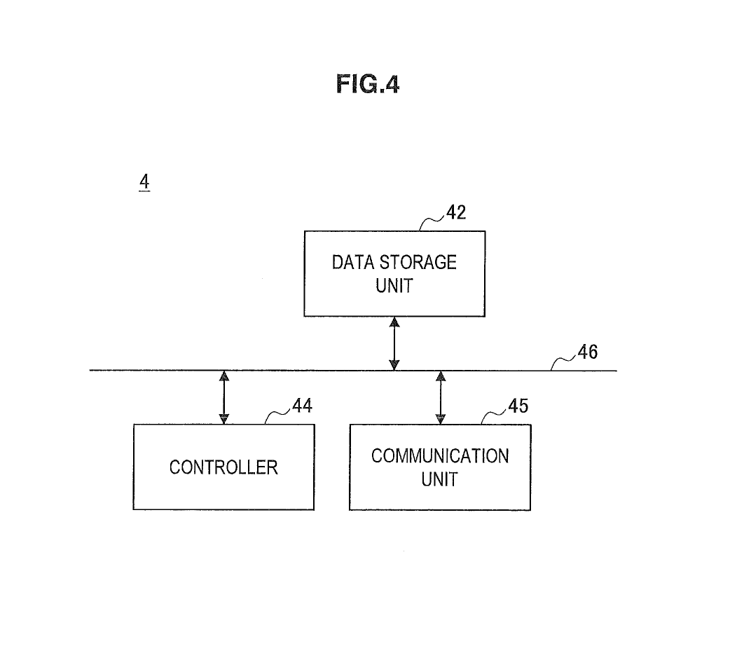

In this way, in a content information management system according to the first embodiment, content information and identification information indicating a user 3 are associated by an automatic imaging device 2-1 disposed near the user 3, and stored in the server 4. Thus, the user 3 is later able to use his or her own identification information to access data recording audio/video of him- or herself stored in the server 4. Next, configurations of the automatic imaging device 2-1 and the server 4 included in a content information management system according to the first embodiment will be successively described with reference to FIGS. 3 and 4.

(Automatic Imaging Device)

FIG. 3 is a diagram illustrating a configuration of an automatic imaging device 2-1 according to the first embodiment. As illustrated in FIG. 3, the automatic imaging device 2-1 includes an imaging unit 20, a mic 21, a data storage unit 22, an identification signal receiver 23, a controller 24, and a communication unit 25. In addition, the respective components of the automatic imaging device 2-1 communicate with each other via a bus 26.

Imaging Unit

The imaging unit 20 includes an image sensor, imaging optics that include an imaging lens, and a recorded image signal processor. The camera module outputs data of a recorded image in the form of a digital signal. Note that the image sensor is realized by a charge-coupled device (CCD) imager or a complementary metal-oxide-semiconductor (CMOS) imager, for example.

Mic

The mic 21 picks up nearby sounds, converts the sounds into a digital signal via an amp and an analog-to-digital converter (ADC), and outputs audio data.

Data Storage Unit

The data storage unit 22 stores recorded audio/video storage data linked to identification information. At this point, the data storage unit 22 may also compress the storage data for storage. The data storage unit 22 is realized with a recording medium such as a memory card or other flash memory, a Digital Versatile Disc (DVD), or a hard disk, for example.

Identification Signal Receiver

The identification signal receiver 23 includes functionality for receiving an identification signal emitted by the identification signal emitting device 1. The identification signal receiver 23 may also include functionality for emitting a trigger causing the identification signal emitting device 1 to emit an identification signal. For example, in the case where the identification signal emitting device 1 is a radio information code, the identification signal receiver 23 emits a radio wave to the identification signal emitting device 1, and receives a reflected radio wave with an identification signal added by the identification signal emitting device 1.

Controller

The controller 24 functions as a computational processing device and control device, and controls overall operation inside the automatic imaging device 2-1 by following various programs. The controller 24 is realized with a central processing unit (CPU) or microprocessor, for example. Note that the controller 24 may also include read-only memory (ROM) that stores information such as programs to use and computational parameters, as well as random access memory (RAM) that temporarily stores information such as parameters that change as appropriate.

For example, the controller 24 identifies a user 3 on the basis of an identification signal received by the identification signal receiver 23, and causes identification information indicating the identified user 3 to be linked to respective audio/video data recorded by the imaging unit 20 and the mic 21, and stored in the data storage unit 22. Also, as discussed above, the controller 24 may also conduct processing such as face recognition using an image acquired by the imaging unit 20, and identify a user 3.

Communication Unit

The communication unit 25 is a communication interface for data communication with external devices. For example, the communication unit 25 transmits various data stored in the data storage unit 22 to the server 4 via the network 5. Also, when the controller 24 identifies a user 3 on the basis of an identification signal, face recognition processing, or the like, the communication unit 25 may transmit and receive data to and from a database (not illustrated) that manages information such as a face image, identification signal, and identification information of a user 3.

(Server)

FIG. 4 is a diagram illustrating a configuration of a server 4 according to the first embodiment. As illustrated in FIG. 4, the server 4 includes a data storage unit 42, a controller 44, and a communication unit 45. In addition, the respective components of the server 4 communicate with each other via a bus 46.

Communication Unit

The communication unit 45 is a communication interface for data communication with external devices. For example, the communication unit 45 receives various data transmitted by the automatic imaging device 2-1. Additionally, when a user 3 issues an access request, the communication unit 45 transmits, to the user 3, content information associated with identification information of the user 3 and stored in the data storage unit 42 discussed later.

Data Storage Unit

The data storage unit 42 stores various data transmitted by and received from the automatic imaging device 2-1, or in other words audio/video storage data recorded by the automatic imaging device 2-1, linked to identification information. Similarly to the data storage unit 22, the data storage unit 42 is realized with a recording medium such as a memory card or other flash memory, a DVD, or a hard disk, for example.

Controller

The controller 44 functions as a computational processing device and control device, and controls overall operation inside the server 4 by following various programs. Similarly to the controller 24, the controller 44 may be realized with a CPU or microprocessor, for example, and may also include ROM and RAM.

[2-1-2. Content Information Collection Operations]

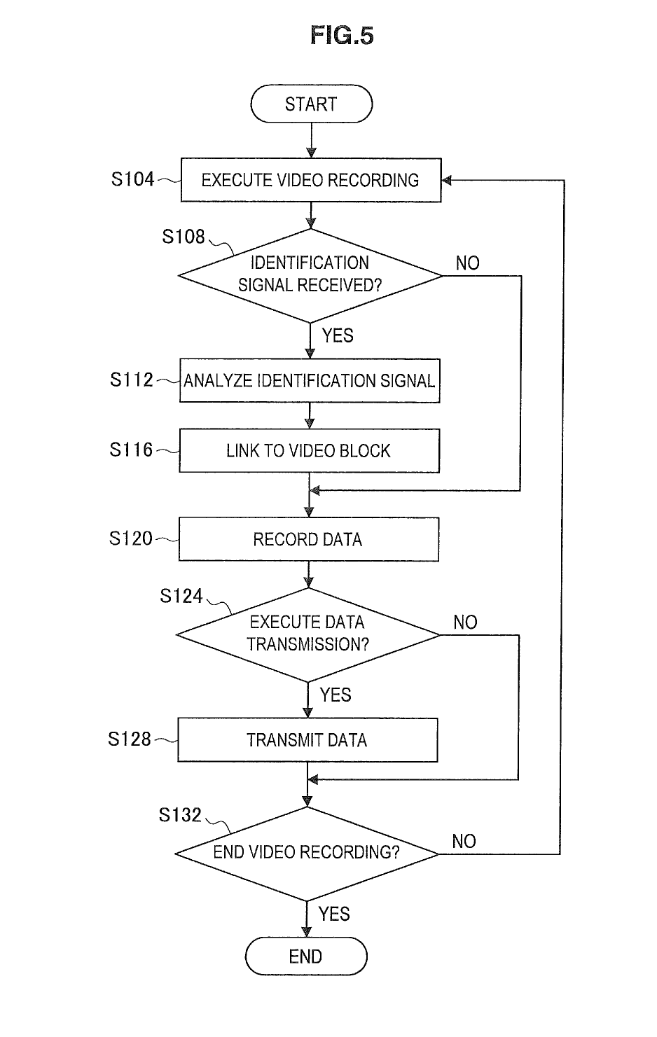

Next, content information collection operations by a content information management system according to the present embodiment will be described with reference to FIG. 5. Specifically, an operational process in which data collected by the automatic imaging device 2-1 is stored in the server 4 will be described.

FIG. 5 is a flowchart illustrating an operational process of an automatic imaging device 2-1 according to the first embodiment. Note that in this specification, data recorded by the imaging unit 20 in particular will be described hereinafter. Furthermore, since explanation regarding audio data recorded by the mic 21 is similar to that regarding recorded video data, such explanation will be reduced or omitted.

First, in step S104, the imaging unit 20 conducts continual video recording.

Subsequently, in step S108 the controller 24 determines whether or not the identification signal receiver 23 has received an identification signal. Note that in the case of identifying a user 3 by processing such as face recognition as discussed earlier, the controller 24 determines whether or not video (or an image) recorded by the imaging unit 20 contains a person.

At this point, in addition to the above conditions, the controller 24 may also determine whether or not video recorded by the imaging unit 20 satisfies a given condition. For example, the controller 24 may also determine whether or not certain conditions are satisfied, such as a user 3 being in a suitable position with respect to a recording spot, his or her face being oriented in the direction of the imaging unit 20, having a smiling expression, and a third party not being included.

Next, in the case where the identification signal receiver 23 receives an identification signal, or in the case where video recorded by the imaging unit 20 contains a person (S108/Yes), in step S112 the controller 24 conducts analysis of the identification signal or a face recognition process on the video, and identifies the user 3.

Subsequently, in step S116 the controller 24 links the video recorded in step S108 with the user 3 identified in step S112, or in other words, identification information indicating the user 3 contained in the video. More specifically, the controller 24 links a video block in arbitrary units such as several seconds or several frames (or in the case of a single frame, an image) with identification information indicating the user 3 contained in that video block.

Then, in step S120 the data storage unit 22 stores the identification information and the video block linked by the controller 24. Note that in the case where the identification signal receiver 23 has not received an identification signal, and in the case where video recorded by the imaging unit 20 does not contain a person (S 108/No), in step S120 the data storage unit 22 stores a video block only.

Note that at this point, the controller 24 may additionally store, in the data storage unit 22, information specifying the coordinates of the user 3 in the video block. For example, the controller 24 may specify the coordinates of the user 3 in the video block by estimation based on information such as the signal strength of an identification signal received by the identification signal receiver 23 or radio wave arrival time, or by processing such as face recognition.

Subsequently, in step S124 the controller 24 determines whether or not to execute data transmission. For example, the controller 24 determines to not execute data transmission in the case where the communication unit 25 is unable to communicate due to factors such as a communication failure on the network 5, or in the case where the current time is outside a data transmit interval. Meanwhile, the controller 24 may determine to execute data transmission in the case where an untransmitted video block linked to identification information is being stored in the data storage unit 22, and determine to not execute data transmission in the case where such a video block is not being stored.

Next, in the case of executing data transmission (S124/Yes), in step S128 the communication unit 25 transmits a video block stored in the data storage unit 22 to the server 4 via the network 5. Note that the communication unit 25 may also selectively transmit only a video block linked to identification information.

At this point, on the server 4 side, the communication unit 45 receives the data transmitted by the communication unit 25. The controller 44 then controls the data storage unit 42 to store video blocks linked to identification information.

Note that although the present embodiment describes an example in which the automatic imaging device 2-1 identifies a user 3 in steps S112 and S116, the present disclosure is not limited to such an example. For example, the server 4 may also conduct steps S112 and S116. In this case, the automatic imaging device 2-1 links a video block to a received identification signal, and transmits the video block linked to the identification signal to the server 4. Subsequently, the controller 44 analyzes the identification signal to identify the user 3, and links the video block to identification information indicating the identified user 3. Otherwise, the automatic imaging device 2-1 may transmit a video block containing a person to the server 4, and the controller 44 may conduct a face recognition process to identify a user 3.

Lastly, in step S132 the controller 24 determines whether or not to end recording by the imaging unit 20. The process by the automatic imaging device 2-1 then proceeds to step S104 in the case of continuing recording (S132/No), whereas the process ends in the case of ending recording (S132/Yes).

(Supplemental Remarks)

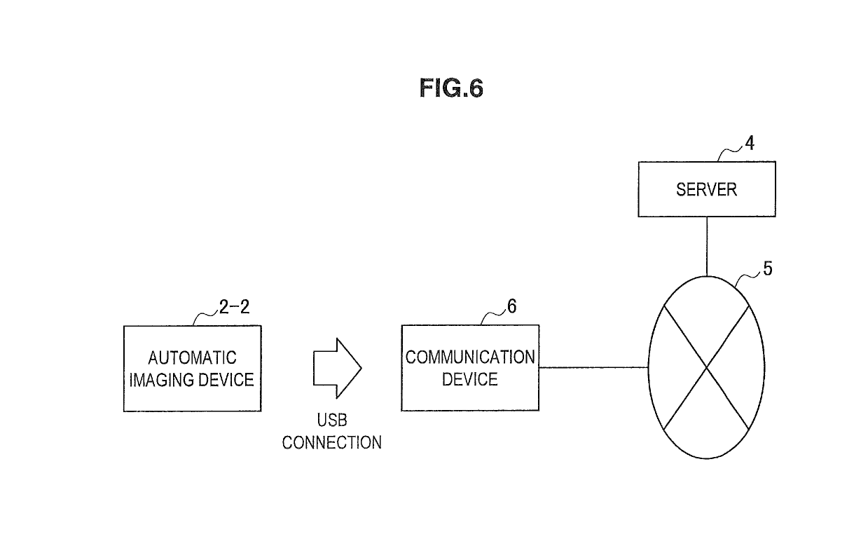

With regard to the above steps S124 and S128, in some cases the automatic imaging device 2 may not include the communication unit 25. An operational process for this case will be described with reference to FIG. 6.

FIG. 6 is a diagram for explaining an example of a process that transmits data stored in an automatic imaging device 2 according to the first embodiment. As illustrated in FIG. 6, an automatic imaging device 2-2 that does not include a communication unit 25 relays, by a USB connection or the like, various stored data to a communication device 6 having communication functions. The communication device 6 then transmits the relayed data to the server 4 via the network 5. Such a communication device 6 is realized by a device such as a personal computer (PC), a smartphone, or a mobile phone, for example.

Note that although the above describes an example in which the automatic imaging device 2-1 or the server 4 identifies a user 3, the communication device 6 may also identify a user 3.

[2-1-3. Content Information Access]

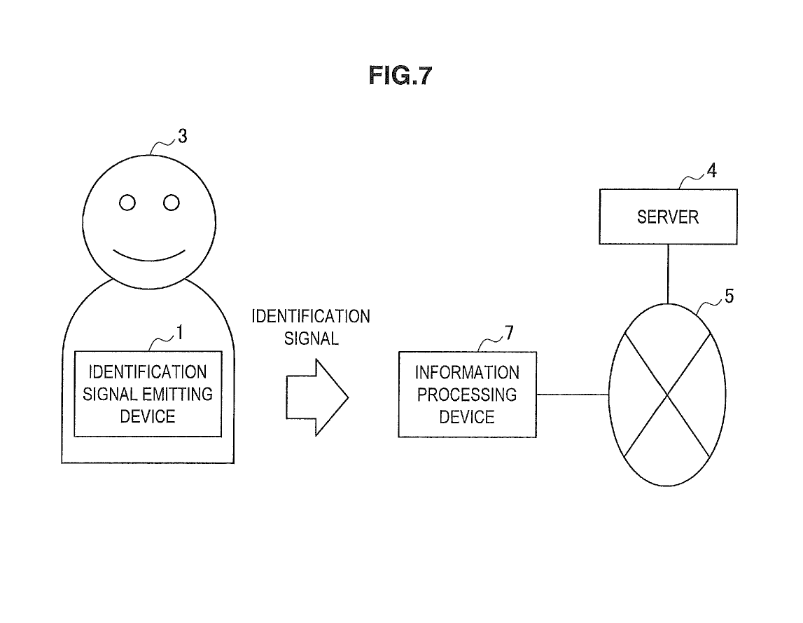

The foregoing thus describes content information collection operations by an automatic imaging device 2-1 and a server 4 according to the present embodiment. Next, content information access by a content information management system according to the present embodiment will be described. As discussed earlier, a user 3 is later able to use his or her own identification information to access data recording audio/video of him- or herself stored in the server 4. Herein, accessing a video block linked to identification information of a user 3 from an arbitrary information processing device will be described. First, accessing the server 4 using an arbitrary information processing device will be summarized with reference to FIG. 7.

FIG. 7 is a diagram summarizing content information access by a content information management system according to the first embodiment. As illustrated in FIG. 7, a user 3 accesses a server 4 using an information processing device 7 (external client) that connects to the server 4 via a network 5.

The information processing device 7 includes communication functions, receiving an identification signal indicating a user 3 from an identification signal emitting device 1, and generating an access request that includes identification information indicating the user 3 requesting access (hereinafter also referred to as second identification information). In addition, the information processing device 7 transmits the generated access request to the server 4 via the network 5, and accesses a video block whose linked identification information (hereinafter also referred to as first identification information) indicates the user 3. Note that besides communication functionality, the information processing device 7 also includes a display unit realized with a cathode ray tube (CRT) display device, a liquid crystal display (LCD) device, or the like, and is able to display an accessed video block. Such an information processing device 7 is realized by a device such as a PC, a smartphone, or a mobile phone, for example.

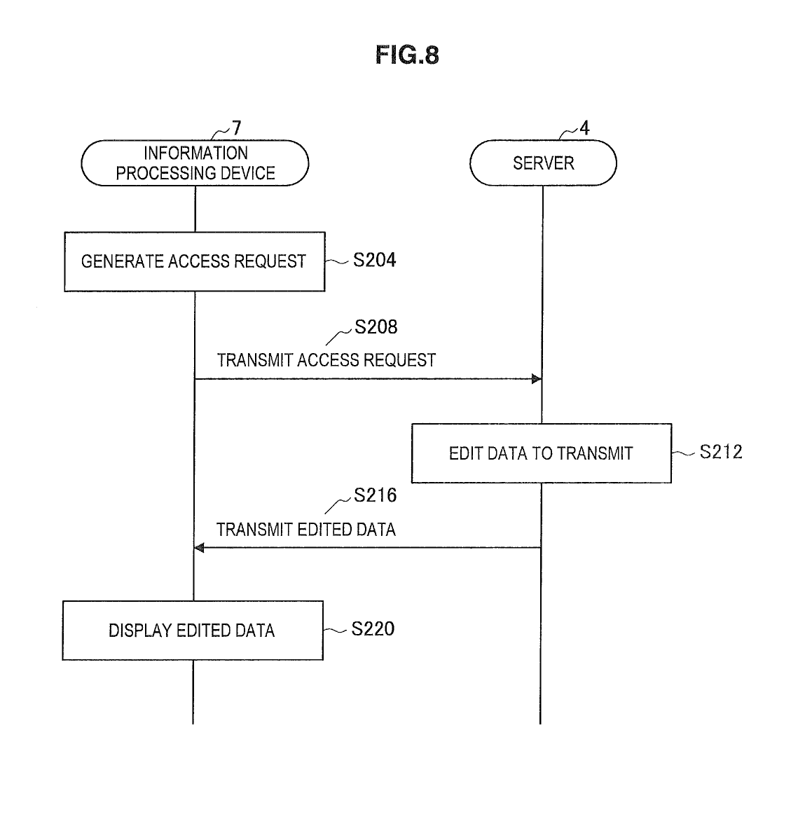

Next, content information access operations according to the present embodiment will be described with reference to FIG. 8. FIG. 8 is a sequence diagram illustrating a content information access operational process according to the first embodiment.

First, in step S204, the information processing device 7 receives an identification signal emitted by an identification signal emitting device 1, additionally analyzes the identification signal to identify a user 3, and generates an access request that includes identification information indicating the user 3 requesting access (second identification information). Note that the information processing device 7 may also identify a user 3 with processing such as face recognition, as discussed earlier. The access request also includes access level information indicating the degree of access restrictions.

Note that the access request may also contain a passcode for authenticating with the server 4. In addition, the access level information and passcode may be emitted by the identification signal emitting device 1. Also, instead of an identification signal, the information processing device 7 may receive input of second identification information, access level information, and a passcode from a user 3, and generate an access request on the basis of the input information.

Next, in step S208 the information processing device 7 transmits an access request to the server 4.

Then, upon receiving the access request, in step S212 the server 4 edits data for transmission to the information processing device 7. More specifically, the controller 44 restricts access to a video block on the basis of information included in the access request and first identification information linked to the video block. The controller 44 then edits data such that only a video block whose access is allowed and not restricted becomes data to be transmitted to the information processing device 7. Such a data editing process will be later described in detail.

Note that although the present embodiment describes an example of the controller 44 editing data to transmit upon receiving an access request, the present disclosure is not limited to such an example. For example, the controller 44 may edit data to transmit at arbitrary timings, such as upon receiving a video block linked to identification information from the automatic imaging device 2-1, and store the edited data in the data storage unit 42.

Next, in step S216 the communication unit 45 transmits edited data to the information processing device 7.

Lastly, upon receiving edited data from the server 4, in step S220 the information processing device 7 displays the received data on a display unit.

(Data Editing Process)

Hereinafter, the data editing process conducted by the controller 44 in step S212 will be described in detail. As discussed above, the controller 44 restricts access to a video block on the basis of information included in the access request and first identification information linked to the video block.

Herein, an access request contains second identification information and access level information. The controller 44 then restricts access to a video block according to the access level information on the basis of a comparison between the second identification information and first identification information linked to a video block stored in the data storage unit 22.

An access request at least contains first access level information or second access level information, which indicate different degrees of access restrictions. Hereinafter, an access restriction process will be successively described for the case where an access request contains first access level information and second access level information, respectively.

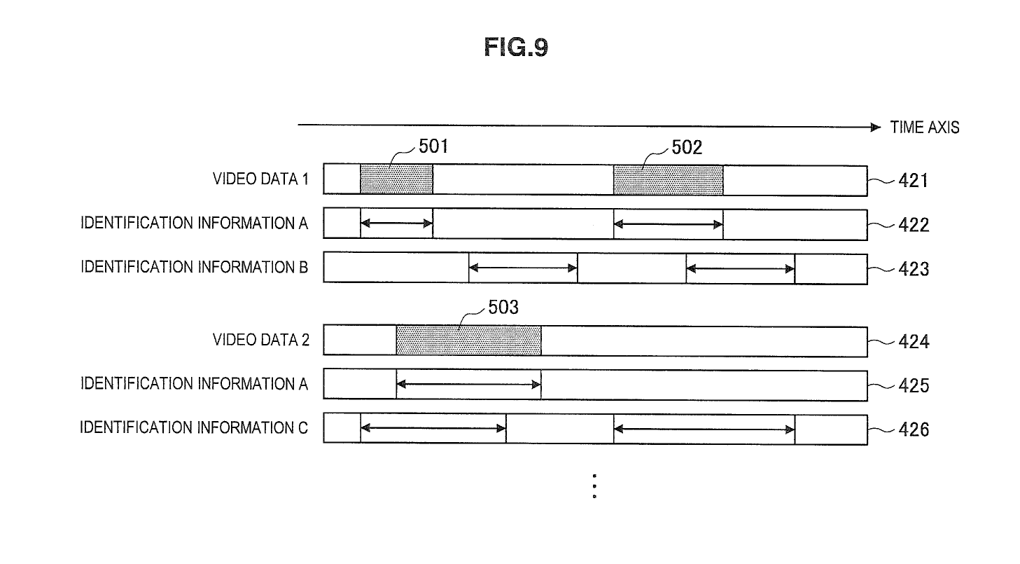

In the case where an access request contains first access level information, the controller 44 grants access only for a video block whose first identification information contains second identification information. Hereinafter, this case will be described using a specific example with reference to FIG. 9.

FIG. 9 is a diagram illustrating an example of an access restriction process by a server 4 according to the first embodiment. As illustrated in FIG. 9, the data storage unit 42 of the server 4 stores video data 1 (421) and video data 2 (424). Herein, the video data 1 (421) is linked to identification information A (422) indicating a user 3A and to identification information B (423) indicating a user 3B. Also, the video data 2 (424) is linked to the identification information A (425) and to identification information C (426) indicating a user 3C. The identification information A to C herein corresponds to the first identification information discussed earlier.

Additionally, assume that an access request received by the server 4 from an information processing device 7 contains second identification information indicating the access requester (the user 3A) and first access level information. In this case, the controller 44 grants access to video data whose first identification information contains second identification information that is the identification information A indicating the user 3A. Specifically, the controller 44 grants access to video blocks 501, 502, and 503.

Meanwhile, in the case where an access request contains second access level information, the controller 44 grants access only for a video block whose first identification information contains second identification information, or third identification information indicating a person tied to the user 3 requesting access.

Herein, a person tied to a user 3 may be a person such as a friend or family of the user 3, for example. Thus, in order to acquire third identification information (information indicating persons such as friends or family of the user 3 requesting access), the controller 44 may control the communication unit 45 to transmit and receive data to and from a database (not illustrated) that manages third identification information corresponding with identification information of the user 3.

Note that when a person such as a friend or family of a user 3 grants the user 3 access permissions to a video block depicting that person, third identification information is set in a database or the like as third identification information corresponding to identification information of the user 3. At this point, a person such as a friend or family of the user 3 may also set a privacy level for the user 3 with respect to a video block depicting that person. The server 4 may then grant access to a video block that satisfies the privacy level from among video blocks whose first identification information contains the third identification information. For example, by using a privacy level, a person such as a friend or family of a user 3 is able to grant the user 3 access to a video block that satisfies certain conditions from among video blocks depicting that person, such as a video that was shot outdoors, or a video depicting friends shared in common with the user 3. Otherwise, a person such as a friend or family of the user 3 may set a privacy level by specifying a time and date or a place (location information), and thereby grant the user 3 access to a video block from when that person went on a trip together with the user 3, for example.

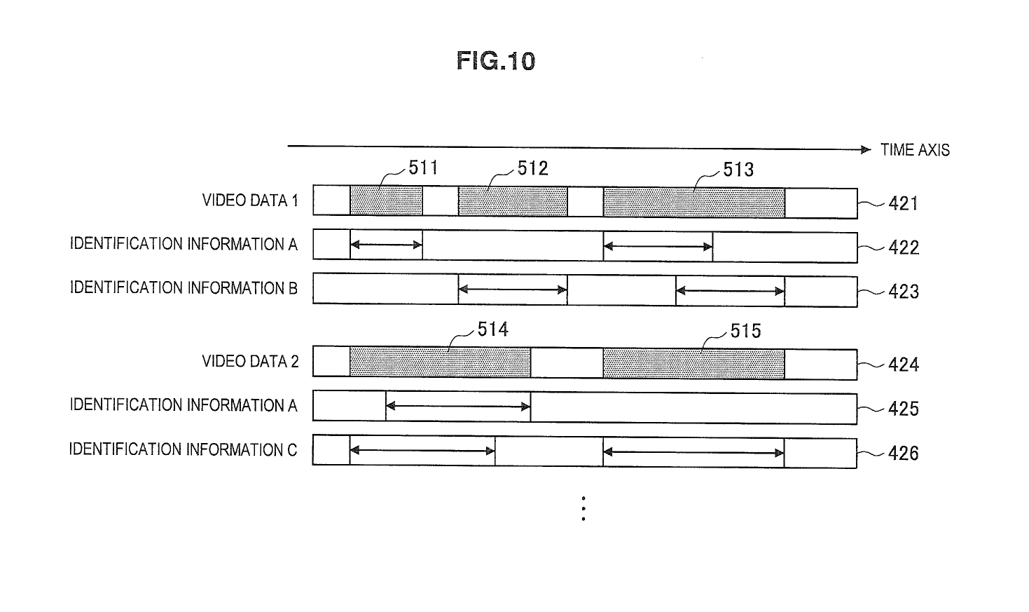

Hereinafter, an access restriction process for the case where an access request contains second access level information will be described using a specific example with reference to FIG. 10.

FIG. 10 is a diagram illustrating an example of an access restriction process by a server 4 according to the first embodiment. As illustrated in FIG. 10, the data storage unit 42 of the server 4 similarly stores video data 1 (421) and video data 2 (424), as described above with reference to FIG. 9.

Additionally, assume that an access request contains second identification information indicating the user 3A and second access level information. Also assume that the user 3A is friends with the users 3B and 3C, and that the controller 44 has acquired identification information indicating 3B and 3C as third identification information. In this case, the controller 44 grants access to video data whose first identification information contains second identification information that is the identification information A indicating the user 3A, or third identification information that is identification signals B and C indicating the users 3B and 3C. Specifically, the controller 44 grants access to video blocks 511, 512, 513, 514, and 515.

First Modification of Data Editing Process)

Although the foregoing access restriction process describes an example of the controller 44 granting or restricting access to a video block, the present disclosure is not limited to such an example. For example, the controller 44 may also grant or restrict access to a given area in a video (a video area).

In this case, the controller 44 restricts access to a video area according to the access level information on the basis of a comparison between the second identification information and first identification information linked to a video block stored in the data storage unit 22.

Note that restricting access to a video area refers to altering a video area depicting a person who is the subject of the access restriction, so as to inhibit the identifiability of the person depicted in a video block. For example, restricting access to a video area may be realized by overwriting a person's entire body, facial area, or the like with a given image, or by applying mosaic, blur, or other processing. Additionally, for the purpose of such processing, the controller 44 may also use information specifying the coordinates of a user 3 in a video block, as described in step S120 with reference to FIG. 7.

Also, in the case where an access request contains first access level information, the controller 44 restricts access to a video area depicting a third party other than a person indicated by the second identification information. Meanwhile, in the case where an access request contains second access level information, the controller 44 restricts access to a video area depicting a third party other than a person indicated by the second identification information or the third identification information.

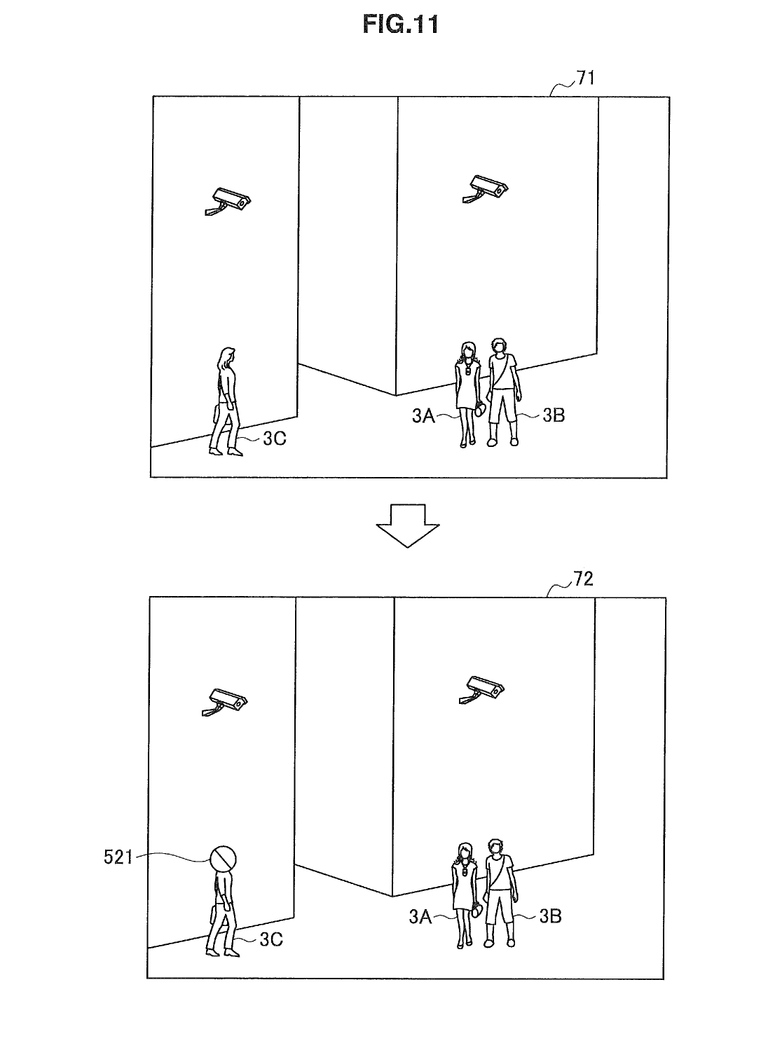

Hereinafter, an exemplary display of a video block displayed by an information processing device 7 (step S220) in the case where the server 4 restricts access to a video area will be described with reference to FIG. 11.

FIG. 11 is a diagram illustrating an exemplary display of a video block before and after editing by a server 4 according to the first embodiment. FIG. 11 illustrates an exemplary display 71 of a video block that has not been edited by the server 4, as well as an exemplary display 72 of a video block in which the server 4 has restricted access to a video area. The exemplary displays 71 and 72 each depict a user 3A who requests access, a user 3B who is a friend of the user 3A, and a user 3C who is unknown to the user 3A.

Furthermore, assume that an access request contains second identification information indicating the user 3A and second access level information. Thus, in the exemplary display 72, the users 3A and 3B are displayed unaltered, whereas a restricted access mark 521 indicating that access has been restricted is displayed in the face area of the user 3C.

(Second Modification of Data Editing Process)

Although the controller 44 conducts an access restriction process in the data editing process described above, the present disclosure is not limited to such an example. For example, the controller 44 may also conduct various kinds of video processing in order to improve utility when a user 3 views a video block on an information processing device 7. Specifically, the controller 44 may take the data to transmit to be a video digest of multiple video blocks depicting a user 3 that were recorded by automatic imaging devices 2-1 disposed in various locations. Otherwise, the controller 44 may also edit video such that only video blocks in which the proportion of the video block occupied by a user 3 meets or exceeds a given reference value become data to transmit. Additionally, information prescribing whether or not to execute such various kinds of data editing may also be contained in an access request.

Note that the controller 44 may also edit data with a combination of the data editing process as well as the first and second modifications of the data editing process described above.

(Supplemental Remarks)

Although the foregoing describes an example in which an access request contains identification information indicating a user 3 him- or herself, the present disclosure is not limited to such an example. For example, an access request may also contain information such as identification information for another person. Specifically, if a user 3 generates an access request by specifying the face of another person depicted in video depicting the user 3 him- or herself, the specified other person may be identified by face recognition processing, and the user 3 may access video depicting that other person.

[2-1-4. Effects]

As described above, since an automatic imaging device 2-1 according to the present embodiment does not require operations such as pressing a shutter button, a user 3 is able to acquire video of him- or herself, family, and friends without assuming the burden of recording video. Also, since automatic imaging devices 2-1 are multiply disposed throughout an area and record video automatically, a user 3 is able to acquire video of one's natural expressions and mannerisms without being camera-conscious, and furthermore without missing momentary happenings.

In addition, in the case where an access request contains first access level information, the server 4 grants access only for a video block whose first identification information contains second identification information. For this reason, by adding his or her own identification information to an access request, a user 3 is able to acquire only video linked to his or her own identification information. Consequently, even if the amount of video recorded by automatic imaging devices 2-1 is very large, the user 3 is able to easily acquire only video depicting him- or herself.

In addition, in the case where an access request contains second access level information, the server 4 grants access only for a video block whose first identification information contains second identification information or third identification information. For this reason, a user 3 is easily able to acquire video depicting a person tied to the user 3, such as a friend or family of the user 3. In other words, by setting third identification information, a user 3 is able to share video depicting him- or herself with persons such as friends and family.

For example, a user 3 is able to acquire a large amount of video from automatic imaging devices 2-1 at an event such as a wedding ceremony, a school entrance ceremony, or a graduation ceremony. Moreover, the user 3 is able to acquire edited data that has been edited in various ways, such as extracting only video depicting the user 3 him- or herself, family, and friends from the acquired video.

Furthermore, at a leisure facility such as an amusement park or zoo, a user 3 is able to acquire video of him- or herself participating in an attraction, recorded by a fixed camera installed at a fixed point in the attraction. Also, in the case where an automatic imaging device 2-1 records video under the condition that a user 3 is suitably positioned with respect to a recording spot, the user 3 is able to acquire video at a recording spot without assuming the burden of recording video. In addition, since a user 3 does not assume the burden of recording video, the user 3 is able to fully enjoy the leisure itself.

Meanwhile, the server 4 is able to impose incremental access restrictions on a video block depicting a user 3, on the basis of third identification information. For this reason, a user 3 is able to grant only him- or herself and persons such as his or her family and friends access to video depicting the user 3, and thereby protect his or her privacy. The server 4 is also able to additionally impose incremental access restrictions on the basis of third identification information and a privacy level.

### 2-2. First Modification of First Embodiment

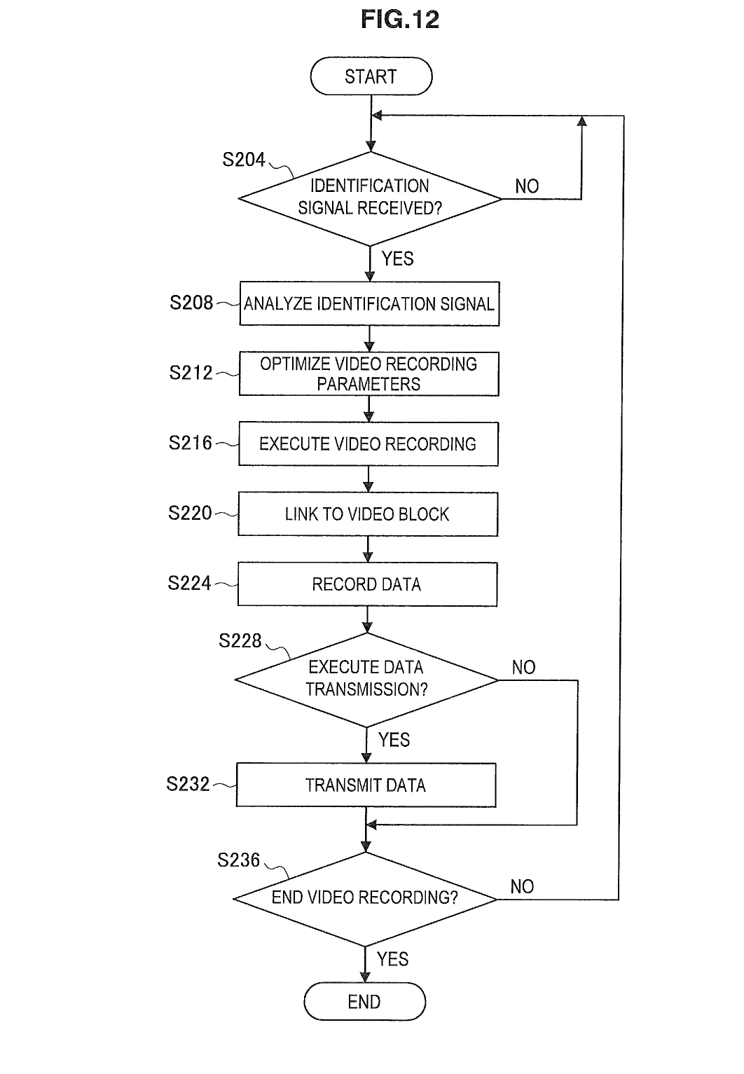

According to the present modification, a content information management system is able to provide a user 3 with content information acquired according with optimized parameters. Since the configuration of a content information management system according to the present modification is as described by the configuration in section <2-1. First embodiment>, detailed description will be reduced or omitted herein. Hereinafter, content information collection operations by a content information management system according to the present modification will be described with reference to FIG. 12. Specifically, a data collection process conducted by an automatic imaging device 2 will be described.

[2-2-1. Operation]

FIG. 12 is a flowchart illustrating an operational process of an automatic imaging device 2 according to a first modification of the first embodiment. Note that hereinafter in this specification, an example in which an automatic imaging device 2 identifies a user 3 with an identification signal will be described, whereas descriptions of processing such as face recognition, as well as an example in which the server 4 identifies a user 3, will be reduced or omitted.

Also, an automatic imaging device 2 according to the present modification has a similar configuration as the automatic imaging device 2-1 described earlier with reference to FIG. 3, and thus will be hereinafter designated an automatic imaging device 2-1′.

First, in step S204 the controller 24 determines whether or not the identification signal receiver 23 has received an identification signal.

Next, in the case where the identification signal receiver 23 receives an identification signal (S204/Yes), in step S208 the controller 24 analyzes the identification signal and identifies a user 3. Meanwhile, in the case where the identification signal receiver 23 does not receive an identification signal (S204/No), the automatic imaging device 2-1′ stands by until receiving an identification signal.

Subsequently, in step S212 the controller 24 optimizes parameters for recording video with the imaging unit 20. For example, the controller 24 optimizes parameters such as the shooting direction, angle of view, focus point, zoom level, and exposure level of the imaging unit 20 according to the position of the identification signal emitting device 1. At this point, the controller 24 may also use identification information of the user 3 identified in step S204 to acquire information such as the height, age, and gender of the user 3 from a database (not illustrated) via the communication unit 25, and use the acquired information during the optimization. For example, the controller 24 is able to more accurately record video of the user 3's face by controlling the imaging unit 20 to use the user 3's height information to adjust the angle of view and zoom to a range able to capture the user 3's face.

After that, in step S216 the imaging unit 20 records video on the basis of the parameters optimized by the controller 24.

Since the subsequent processing in step S220 and thereafter is similar to the processing in step S116 and thereafter described above with reference to FIG. 5, further description herein is omitted.

[2-2-2. Effects]

As described above, an automatic imaging device 2-1′ according to the present modification records video when triggered by receiving an identification signal. Consequently, since the automatic imaging device 2-1′ has less data to store in the data storage unit 22 compared to the example of continual recording, the storage capacity of the data storage unit 22 may be reduced.

Additionally, the automatic imaging device 2-1′ optimizes parameters for recording video with the imaging unit 20. Consequently, the automatic imaging device 2-1′ is able to provide a user 3 with sharper video compared to the example of not adjusting parameters.

### 2-3. Second Modification of First Embodiment

According to the present modification, a content information management system is able to provide a user 3 with content information acquired from the perspectives of various people. As discussed above, besides being a fixed camera installed at a fixed point, an automatic imaging device 2 according to the present embodiment may also be a wearable device. Thus, by having automatic imaging devices 2 worn by respective users record each other, a user 3 is able to acquire images recorded from the perspectives of various people. In the present modification, such a wearable automatic imaging device 2 will be described.

[2-3-1. Configuration and Operation]

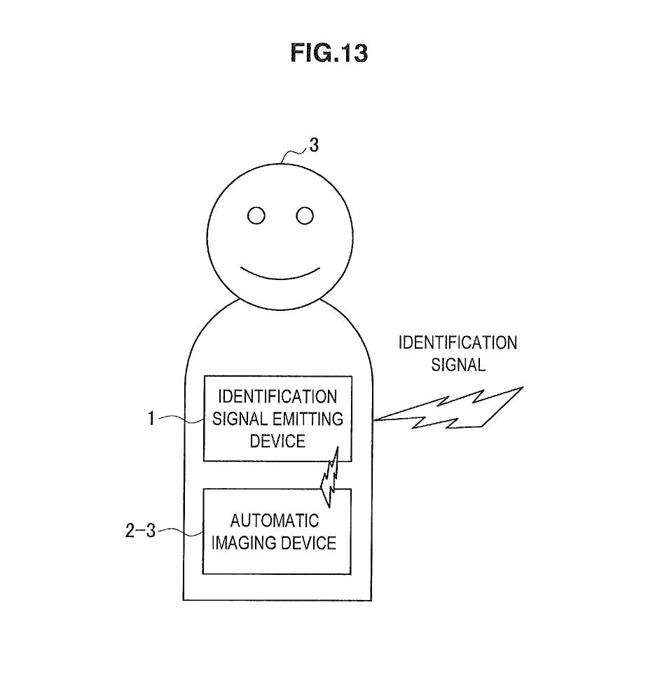

FIG. 13 is a diagram for summarizing a content information management system according to a second modification of the first embodiment. As illustrated in FIG. 13, the content information management system includes an identification signal emitting device 1 and an automatic imaging device 2-3 worn by a user 3. For example, a user 3 may wear an automatic imaging device 2-3 such that a face provided with an imaging lens is in front. Note that the configuration of the automatic imaging device 2-3 is similar to the configuration of the automatic imaging device 2-1 described above with reference to FIG. 3.

An identification signal emitted by an identification signal emitting device 1 worn by a user 3 is received by an automatic imaging device 2 able to record the user 3, as described above with reference to FIGS. 2 and 7. However, in the present modification, an identification signal emitted by an identification signal emitting device 1 worn by a user 3 is also received by an automatic imaging device 2-3 worn by the same user 3. In this case, the automatic imaging device 2-3 functions as a life logging camera that continually records a user 3's daily life and activities. Note that an automatic imaging device 2-3 may also be preset with identification information for a user 3.

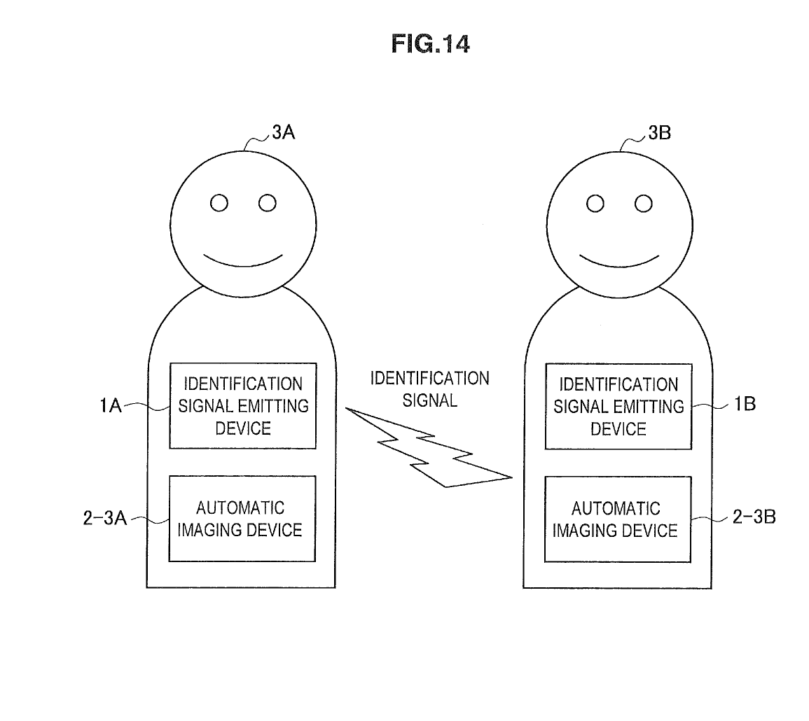

Then, in the case where multiple users 3 wearing automatic imaging devices 2-3 come face-to-face, an identification signal emitted by an identification signal emitting device 1 worn by a user 3 is received by an automatic imaging device 2-3 possessed by a facing user 3. Hereinafter, this case will be described using a specific example with reference to FIG. 14.

FIG. 14 is a diagram for summarizing a content information management system according to a second modification of the first embodiment. In FIG. 14, a user 3A and a user 3B are face-to-face, each wearing an identification signal emitting device 1 (1A, 1B) and an automatic imaging device 2-3 (2-3A, 2-3B).

An identification signal emitted by the identification signal emitting device 1-A worn by the user 3A is received by the automatic imaging device 2-3B worn by the facing user 3B. The automatic imaging device 2-3B then links recorded video to identification information based on the identification signal emitted by the identification signal emitting device 1-A, and transmits the linked information to the server 4.

[2-3-2. Effects]

As described above, an automatic imaging device 2-3 according to the present embodiment is able to function as a life logging camera for a user 3. More particularly, since an automatic imaging device 2-3 is worn by a user 3, the user 3 is able to acquire from the perspective of the user 3.

In addition, the automatic imaging device 2-3 also functions as an automatic imaging device 2 described earlier for another person depicted in recorded video. Consequently, another person recorded by an automatic imaging device 2-3 is able to access video depicting that person from among the recorded video. In this way, a user 3 is able to able acquire video from another person's perspective in the case of situations such as talking to or passing by another person wearing an automatic imaging device 2-3.

For this reason, a user 3 is able to acquire video from the perspectives of various people. For example, at a school entrance ceremony, a user 3 is able to acquire diverse video from perspectives such as the perspectives of children attending the entrance ceremony, and the perspectives of the user 3, who is a parent. Also, at a zoo, a user 3 is able to acquire video of the user 3 from the perspective of an animal wearing an automatic imaging device 2-3.

Note that the identification signal emitting device 1 and the automatic imaging device 2-3 may also be integrally formed and worn together by a user.

### 2-4. Second Embodiment

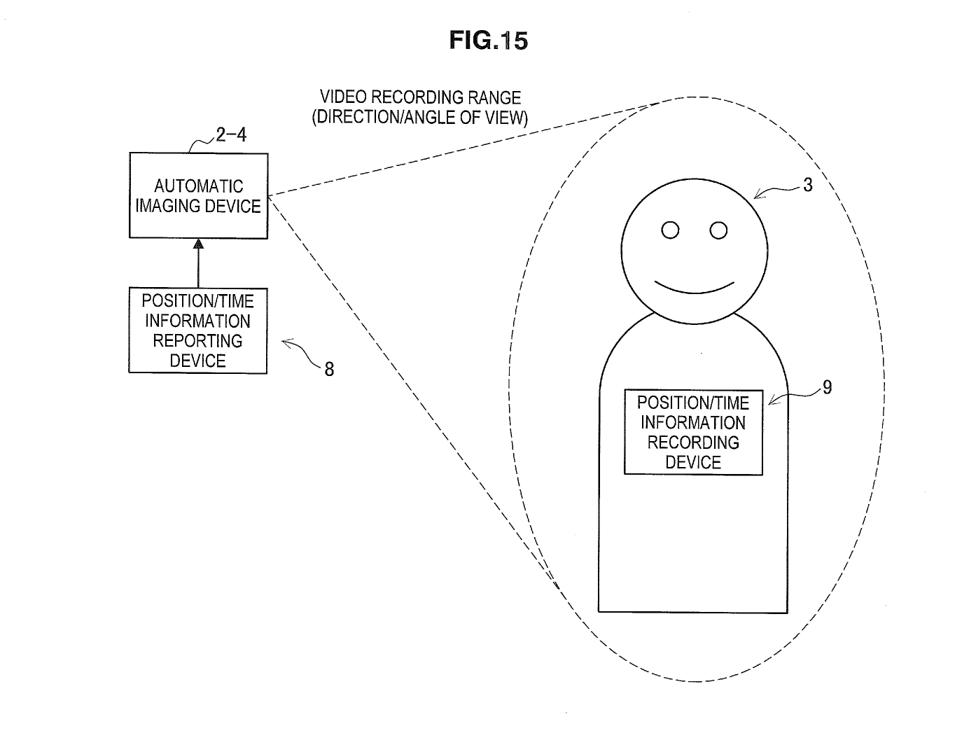

In addition, according to the present embodiment, it is possible to restrict access on the basis of a behavior history and a recording history. Hereinafter, a configuration of a content information management system according to the present embodiment will be described with reference to FIG. 15.

[2-4-1. Configuration]

FIG. 15 is a diagram illustrating a configuration of a content information management system according to the second embodiment. As illustrated in FIG. 15, the content information management system includes a position/time information recording device 9 worn by the user 3, as well as an automatic imaging device 2-4 and a position/time information reporting device 8 which are adjacent to each other or integrally formed.

The position/time information reporting device 8 detects the position where the automatic imaging device 2-4 exists, and outputs position information and time information indicating the current time. For example, the position/time information reporting device 8 detects the position where the automatic imaging device 2-4 exists by receiving radio waves from Global Positioning System (GPS) satellites.

The automatic imaging device 2-4 includes a similar configuration as the automatic imaging device 2-1 described above with reference to FIG. 3. However, since the automatic imaging device 2-4 does not identify a user 3 by an identification signal or face recognition processing as discussed later, the identification signal receiver 23 may not be included.

The position/time information recording device 9 detects the position where a user 3 wearing the position/time information recording device 9 exists, and records a behavior history indicating a time series of changes in the position of the user 3. The position/time information recording device 9 is realized by a device such as a GPS logger or mobile phone, for example.

Note that the automatic imaging device 2-4 and the position/time information recording device 9 may also be worn by a user 3, as described earlier with reference to FIGS. 13 and 14.

[2-4-2. Operation]

The above thus summarizes a configuration of a content information management system according to the present embodiment. Next, content information collection operations and content information access operations by a content information management system according to the present embodiment will be described.

(Content Information Collection Operations)

The automatic imaging device 2-4 associates recorded data with information such as position and time information output by the position/time information reporting device 8, as well as shooting direction and angle of view information indicating the recording range of the imaging unit 20. More specifically, the automatic imaging device 2-4 links, to a video block, a recording history (content information acquisition history) indicating a time series of changes in a recording target range combining a position and a recording range, and transmits the linked information to the server 4 for storage in the data storage unit 42.

(Content Information Access Operations)

Content information access operations are similar to the operations described earlier with reference to FIGS. 7 to 11. However, an access request that an information processing device 7 transmits to the server 4 according to the present embodiment contains a behavior history and access level information.

Herein, the server 4 stores a video block linked to a recording history in the data storage unit 42. Then, by cross-referencing the recording history with a behavior history contained in an access request, the controller 44 identifies a user 3 depicted in a video block, and restricts access to the video block.

Specifically, in the case where the recording range indicated by the recording history at a particular time matches a position indicated by the behavior history, the controller 44 identifies the user 3 depicted in the matching part of the video block as the person who transmitted the access request. The controller 44 then conducts a data editing process similar to that described above with reference to FIGS. 8 to 11, and transmits edited data to an information processing device 7.

[2-4-3. Effects]

As described above, a server 4 according to the present embodiment restricts access to a video block on the basis of a behavior history and a recording history. For this reason, since only a recording history is linked to a video block and stored, it is possible to reduce the storage capacity of the data storage unit 42 in the server 4 compared to the example of linking and storing identification information for multiple persons depicted in a video block.

Additionally, since the server 4 identifies a user 3 on the basis of a behavior history and a recording history, it is possible to identify a user 3 even in conditions where the video is unclear and face recognition processing is difficult due to factors such as nighttime or bad weather.

### 3. Conclusion

The foregoing thus describes preferred embodiments of the present disclosure in detail and with reference to the attached drawings. However, the technical scope of the present disclosure is not limited to such examples. It is clear to persons ordinarily skilled in the technical field of the present disclosure that various modifications or alterations may occur insofar as they are within the scope of the technical ideas stated in the claims, and it is to be understood that such modifications or alterations obviously belong to the technical scope of the present disclosure.

For example, in the foregoing embodiments, a client device according to the present disclosure is described as an automatic imaging device 2 and an information processing device 7 with distinct functions, but the present technology is not limited to such an example. An automatic imaging device 2 and an information processing device 7 may also be integrally formed.

Additionally, in the foregoing embodiments, identification information indicating a person is linked to a video block in the case where the video block depicts that person, but the present technology is not limited to such an example. For example, identification information indicating a person may also be linked to a video block in the case where the video block depicts a personal possession of that person. By linking identification information indicating a user 3 to a video block depicting the user 3's pet or car, for example, the user 3 is able to easily find a missing pet or car from a linked video block.

Additionally, the present technology may also be configured as below:

(1) A client device, including:

an identification unit that identifies a person included in content information acquired by a content information acquisition unit, and generates first identification information indicating an identified person;

a communication unit that associates and transmits the content information and the first identification information to an external device; and

a generation unit that generates an access request for content information being stored in the external device,

wherein the access request includes second identification information specifying a user who accesses the content information being stored in the external device, and

the communication unit transmits the access request to the external device, and from the external device receives content information that is at least partially access-restricted based on a comparison by the external device between the second identification information included in the access request and the first identification information associated with the content information being stored in the external device.

(2) The client device according to (1), wherein

the access request also includes access level information indicating a degree of access restrictions, and

the communication unit receives, from the external device, content information that is at least partially access-restricted according to the access level information.

(3) The client device according to (2), wherein

the access request includes at least first access level information or second access level information, and

in a case where the access request includes the first access level information, the communication unit receives only content information whose first identification information associated with the content information includes second identification information that at least specifies the user, and in a case where the access request includes the second access level information, the communication unit receives only content information whose first identification information associated with the content information includes third identification information that specifies a person tied to the second identification information or to the user.

(4) The client device according to any one of (1) to (3), wherein

the content information that is at least partially access-restricted is content information that has been altered so as to inhibit identifiability of a portion containing a third party other than the user.

(5) The client device according to any one of (1) to (4), wherein

the content information acquisition unit is an imaging unit that acquires a recorded image as content information, and

the identification unit identifies a person included in the content information and generates the first identification information by conducting an image recognition process on a recorded image recorded by the imaging unit.

(6) The client device according to any one of (1) to (5), further including:

a reception unit that receives an identification signal emitted by an identification signal emitting device, wherein

the identification signal is a signal that indicates a person who possesses the identification signal emitting device, and

the identification unit generates first identification information indicating the identified person based on the identification signal received by the reception unit.

(7) The client device according to (6), wherein

the content information acquisition unit acquires the content information continually, or at a timing when the reception unit receives the identification signal from the identification signal emitting device.

(8) The client device according to (6) or (7), wherein

the content information acquisition unit optimizes content information acquisition parameters according to a position of the identification signal emitting device.

(9) The client device according to any one of (6) to (8), wherein

the generation unit generates second identification information specifying the user based on the identification signal received by the reception unit.

(10) The client device according to any one of (6) to (9), wherein

the identification signal emitting device is an optical information code or a radio information code.

(11) The client device according to any one of (1) to (10), wherein

the identification unit identifies a person included in content information acquired by the content information acquisition unit and a person who is using the client device provided with the content information acquisition unit, and generates first identification information indicating an identified person.

(12) The client device according to any one of (1) to (11), wherein

the client device is a wearable device able to be used while worn by a user, a held mobile device able to be used while held by a user, an attached device that attaches to a moving object, a built-in device that is built into a moving object, or an installed device installed at a fixed point.

(13) The client device according to any one of (11) to (12), wherein

the content information is video, an image, audio, or a combination thereof

(14) The client device according to any one of (1) to (13), wherein

the content information is an image, and

the communication unit receives a single video digest of a plurality of pieces of content information associated with first identification information by the external device.

(15) A server, including:

a communication unit that receives content information from a content information acquisition device, and receives an access request from an external client;

an identification unit that identifies a person included in the content information, and generates first identification information indicating the person;

a storage control unit that associates and stores the content information and the first identification information in a storage unit; and

a communication control unit that, when the communication unit receives from the external client the access request including second identification information that specifies a user who accesses the content information being stored in the storage unit, controls the communication unit to transmit, to the external client, content information that is generated and at least partially access-restricted based on a comparison between the second identification information included in the access request and the first identification information associated with the content information being stored in the storage unit.

(16) The server according to (15), wherein

the access request also includes access level information indicating a degree of access restrictions, and

the communication control unit controls the communication unit to transmit, to the external client, content information that is at least partially access-restricted according to the access level information.

(17) The server according to (16), wherein

the access request includes at least first access level information or second access level information, and

the communication control unit controls the communication unit such that, in a case where the access request includes the first access level information, the communication unit transmits, to the external client, only content information whose first identification information associated with the content information includes second identification information that at least specifies the user, and in a case where the access request includes the second access level information, the communication unit transmits, to the external client, only content information whose first identification information associated with the content information includes third identification information that specifies a person tied to the second identification information or to the user.

(18) The server according to any one of (15) to (17), wherein

the communication unit receives, from the content information acquisition device, a content information acquisition history indicating a time series of changes in an acquisition target range of content information, and receives, from the external client, a behavior history of a person possessing the external client, and

the identification unit identifies a person included in the content information based on the content information acquisition history and the behavior history.

(19) A non-transitory computer-readable storage medium having a program stored therein, the program causing a computer to execute:

identifying a person included in content information, and generating first identification information indicating an identified person;

associating and transmitting the content information and the first identification information to an external device;

generating an access request for content information being stored in the external device, the access request including second identification information specifying a user who accesses the content information;

transmitting the access request to the external device; and

receiving, from the external device, content information that is at least partially access-restricted based on a comparison by the external device between the second identification information included in the access request and the first identification information associated with the content information being stored in the external device.

(20) A non-transitory computer-readable storage medium having a program stored therein, the program causing a computer to execute:

receiving content information from a content information acquisition device;

identifying a person included in the content information, and generating first identification information indicating the person;

associating and storing the content information and the first identification information;

receiving, from an external client, an access request including second identification information specifying a user who accesses the stored content information; and

transmitting, to the external client, content information that is generated and at least partially access-restricted based on a comparison between the second identification information included in the access request and the first identification information associated with the stored content information.

The present disclosure contains subject matter related to that disclosed in Japanese Priority Patent Application JP 2012-185281 filed in the Japan Patent Office on Aug. 24, 2012, the entire content of which is hereby incorporated by reference.

What is claimed is:

1. A client device, comprising:
an identification unit that identifies a person included in content information acquired by a content information acquisition unit, and generates first identification information indicating an identified person;
a communication unit that associates and transmits the content information and the first identification information to an external device; and
a generation unit that generates an access request for content information being stored in the external device,
wherein the access request includes second identification information specifying a user who accesses the content information being stored in the external device, and
the communication unit transmits the access request to the external device, and from the external device receives content information that is at least partially access-restricted based on a comparison by the external device between the second identification information included in the access request and the first identification information associated with the content information being stored in the external device.

2. The client device according to claim 1, wherein
the access request also includes access level information indicating a degree of access restrictions, and
the communication unit receives, from the external device, content information that is at least partially access-restricted according to the access level information.

3. The client device according to claim 2, wherein
the access request includes at least first access level information or second access level information, and
in a case where the access request includes the first access level information, the communication unit receives only content information whose first identification information associated with the content information includes second identification information that at least specifies the user, and in a case where the access request includes the second access level information, the communication unit receives only content information whose first identification information associated with the content information includes third identification information that specifies a person tied to the second identification information or to the user.

4. The client device according to claim 1, wherein
the content information that is at least partially access-restricted is content information that has been altered so as to inhibit identifiability of a portion containing a third party other than the user.

5. The client device according to claim 1, wherein
the content information acquisition unit is an imaging unit that acquires a recorded image as content information, and
the identification unit identifies a person included in the content information and generates the first identification information by conducting an image recognition process on a recorded image recorded by the imaging unit.

6. The client device according to claim 1, further comprising:
a reception unit that receives an identification signal emitted by an identification signal emitting device, wherein
the identification signal is a signal that indicates a person who possesses the identification signal emitting device, and
the identification unit generates first identification information indicating the identified person based on the identification signal received by the reception unit.

7. The client device according to claim 6, wherein
the content information acquisition unit acquires the content information continually, or at a timing when the reception unit receives the identification signal from the identification signal emitting device.

8. The client device according to claim 6, wherein
the content information acquisition unit optimizes content information acquisition parameters according to a position of the identification signal emitting device.

9. The client device according to claim 6, wherein
the generation unit generates second identification information specifying the user based on the identification signal received by the reception unit.

10. The client device according to claim 6, wherein
the identification signal emitting device is an optical information code or a radio information code.

11. The client device according to claim 1, wherein
the identification unit identifies a person included in content information acquired by the content information acquisition unit and a person who is using the client device provided with the content information acquisition unit, and generates first identification information indicating an identified person.

12. The client device according to claim 1, wherein
the client device is a wearable device able to be used while worn by a user, a held mobile device able to be used while held by a user, an attached device that attaches to a moving object, a built-in device that is built into a moving object, or an installed device installed at a fixed point.

13. The client device according to claim 1, wherein
the content information is video, an image, audio, or a combination thereof.

14. The client device according to claim 1, wherein
the content information is an image, and
the communication unit receives a single video digest of a plurality of pieces of content information associated with first identification information by the external device.

15. A server, comprising:
a communication unit that receives content information from a content information acquisition device, and receives an access request from an external client;
an identification unit that identifies a person included in the content information, and generates first identification information indicating the person;
a storage control unit that associates and stores the content information and the first identification information in a storage unit; and
a communication control unit that, when the communication unit receives from the external client the access request including second identification information that specifies a user who accesses the content information being stored in the storage unit, controls the communication unit to transmit, to the external client, content information that is generated and at least partially access-restricted based on a comparison between the second identification information included in the access request and the first identification information associated with the content information being stored in the storage unit.

16. The server according to claim 15, wherein
the access request also includes access level information indicating a degree of access restrictions, and
the communication control unit controls the communication unit to transmit, to the external client, content information that is at least partially access-restricted according to the access level information.

17. The server according to claim 16, wherein
the access request includes at least first access level information or second access level information, and
the communication control unit controls the communication unit such that, in a case where the access request includes the first access level information, the communication unit transmits, to the external client, only content information whose first identification information associated with the content information includes second identification information that at least specifies the user, and in a case where the access request includes the second access level information, the communication unit transmits, to the external client, only content information whose first identification information associated with the content information includes third identification information that specifies a person tied to the second identification information or to the user.

18. The server according to claim 15, wherein
the communication unit receives, from the content information acquisition device, a content information acquisition history indicating a time series of changes in an acquisition target range of content information, and receives, from the external client, a behavior history of a person possessing the external client, and
the identification unit identifies a person included in the content information based on the content information acquisition history and the behavior history.

19. A non-transitory computer-readable storage medium having a program stored therein, the program causing a computer to execute:
identifying a person included in content information, and generating first identification information indicating an identified person;
associating and transmitting the content information and the first identification information to an external device;
generating an access request for content information being stored in the external device, the access request including second identification information specifying a user who accesses the content information;
transmitting the access request to the external device; and
receiving, from the external device, content information that is at least partially access-restricted based on a comparison by the external device between the second identification information included in the access request and the first identification information associated with the content information being stored in the external device.

20. A non-transitory computer-readable storage medium having a program stored therein, the program causing a computer to execute:
receiving content information from a content information acquisition device;
identifying a person included in the content information, and generating first identification information indicating the person;
associating and storing the content information and the first identification information;
receiving, from an external client, an access request including second identification information specifying a user who accesses the stored content information; and
transmitting, to the external client, content information that is generated and at least partially access-restricted based on a comparison between the second identification information included in the access request and the first identification information associated with the stored content information.
